(19) United States
(12) Patent Application Publication
(10) Pub. No.: US 2010/0005123 A1
(43) Pub. Date: Jan. 7, 2010

(54) Tracking Manufacturing Test Changes

(75) Inventors: Dayton Norrgard, Fort Collns, CO (US); Chris Jacobsen, Fort Collins, CO (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(73) Assignee: AGILENT TECHNOLOGIES, INC., Loveland, CO (US)

(21) Appl. No.: 12/166,319

(22) Filed: Jul. 1, 2008

(51) Int. Cl. G06F 17/30

(52) U.S. Cl. 707/202; 707/E17.01

(57) ABSTRACT

A process methodology and application for change control monitoring and identification used with a circuit board testing platform. This methodology uses “baselines” to track an approved collection of changes for testing a circuit board. An approver is an authorized user or a user that have permission to modify board-test parameters. Modifications of board-test parameters made by unauthorized persons are reported though a change notification system that can alert quality control systems so corrective action of the change can be taken. The change notification system associates the identity of the circuit board to the changes being made. The system uses digital signature encryption to protect the integrity and verifiability of the data from the test system and prevents data forgery.

### BACKGROUND OF THE INVENTION

Contemporary in-circuit test systems provide manufacturers with a platform to verify a Printed Circuit Board Assembly (PCBA). Challenges brought on by shrinking packages, increased board complexity, limited test access and price pressures, limit the success of these in-circuit test systems. The in-circuit test systems (“test systems”) operate with board-level test files to test the PCBA.

An operator interface may exist to provide limited control to modify the tests performed on the PCBA (“board-tests”). The modifications to the test parameters to certify a board are based on human judgment rather than on quality control. If the need arises, it would be difficult to differentiate a true component failure from a parametric adjustment to the test system.

As a result, these modifications have been difficult to track. Present test systems lack the metrology to detect modifications to the board-tests. Furthermore, these changes are not communicated or sent to a central authority to be managed. This results in a loss of confidence in test quality over time.

A board-test comprises a hierarchy of files. These can include test-plan files, test-order files, wire-list files, and configuration files. A device-level file is one that contains specific topology information and test vectors for a specific device on the board being tested. A device may be any component found on a circuit board, such as connectors, integrated circuits, resistors, capacitors, transistors, switches, jumpers. Device-level files can include a test source file or a test object file.

The area tested (“coverage”) decreases as the board progresses through its life cycle. Coverage is first identified when engineering development concludes. Coverage is reduced during production ramp-up and subsequently during volume production.

Current changes in development and manufacturing have exacerbated the problem of monitoring changes to board-test files. In today's test climate, a test developer might be physically removed from a manufacturer. The developer may specify details of a board-test, but then often hands-off production-level control to a contract manufacturer; making tracking changes to the board-test difficult.

As the production flow for the board matures over time, the board-tests may be edited to adapt for handling engineering change orders and process changes. In addition, changes may be made to the board-test with the emphasis on maximizing shipping volume rather than testing quality. A consequence of lesser coverage of a printed circuit board-under-test is fewer checks on the board. This stems from a desire to reduce the cost of manufacture. Another reason is accessibility to points within a complex or densely populated board. These reasons do not lessen the need to improve the traceability of changes made to a board-test.

Presently, no software applications exist that monitor changes made as a result of human intervention to board-test files, and when such changes affect circuit board assemblies. While software applications are available to provide an environment in which files can be saved under revision control, such architecture to provide this facility is expensive and requires a large investment to support. In the case where applications are available, such applications lack an ability to relate details of the circuit board assembly and details of the change.

As a result, critical changes in the board-test are not accounted for. This problem is exemplified when changes cannot be tied to a specific PCBA. The problem is magnified when changes relative to a quality-approved baseline are made across several testing platforms used for testing the same board type. Early detection, resolution, and traceability to problems in manufacturing can result in savings down the line, especially when resolving failures and product recalls once the product is released to the market.

Accordingly, a need exists to track changes made to a board-test file to improve the traceability of the changes in the production flow and to and make it easier to associate product failures to a manufacturing environment.

### BRIEF DESCRIPTION OF THE DRAWINGS

FIG. 1 is a flow chart describing a board-test production tracking system using baselining;

FIG. 2 is a flow chart showing a sequence for change control detection and notification;

FIG. 3 is an example of a notification log record;

FIG. 4 is a diagram of a testing platform; and

FIG. 5 is a block diagram of a testing facility.

### DETAILED DESCRIPTION

A tracking system is described herewith to address the concerns listed above. The tracking system comprises a method to improve quality-control metrology in a testing platform, such as an in-circuit test system, through a system of checks and balances. The method tracks changes and builds a notification record when the board-test process changes. Such metrology enables auditable tracking which can be utilized for ISO audit controlled process trails.

The tracking system establishes a baseline for a particular board undergoing manufacturing tests (“baselining”). A baseline is an event marker that takes a snapshot of the state of the board-test files at a particular time. This marker identifies and records relevant information on files related to the board-test. The board-test files are generally stored in a board-test directory. Over the course of a product's life cycle, particularly during its manufacturing cycle, product testing continually matures, and as a result, may require fine-tuning and upgrades. These adjustments and maintenance can also be tracked.

Mentioned above, baselining can capture information on the files used in a board-test. This can include the source files and object files of the device tests.

The tracking system can also be used in environments wherein changes made to the product can be tracked to improve traceability. Thus, while the description herewith talks to tests on a (manufacturing) test system, the inventive concept can additionally track a product being tested on a testing platform other than a manufacturing test system. A testing platform is an apparatus to test components of a printed circuit board. The testing platform can test hardware or software components from the conceptual and design phases through manufacture and distribution. Examples of testing platforms include optical inspection systems, X-ray inspection systems, functional test systems, and visual test systems.

The system associates a quality-controlled release of a board-test to a PCBA's serial number or other unique identifier. With this, the system can provide a real time monitor by logging the event at the time of the occurrence and having such log trigger a real time event, such as a pager, email, light tower (red, yellow, green light on system to alert factory floor personnel), or other notification technology.

The tracking system monitors changes and its effect thereon to the manufacture and test of circuit boards. The system can also safe guard against changes to the board-test files after it has been released to production. This is implemented by placing a control mechanism to limit changes and to document the details of such changes when they happen. Similarly, baselining can be used to monitor changes when debugging a board prior to release for production.

The tracking system comprises three phases. A baseline phase establishes a known good working state by storing aside important board information. A detection phase identifies when a change has occurred between a file and its established baseline. A notification phase communicates the change in a signed and verified log record.

The detection phase does not necessarily halt or inhibit the continued testing of the board. Detection is executed as a background process in which the test system is operating on.

Changes may be made on the manufacturing floor or offline in an office environment. If made offline, then these changes can be reposted back to the directory where the board-test files are stored to take effect. These changes may be copied to the test system where the testing is done. Alternatively, the changes can be copied to a server to provide a central copy for all test systems to utilize.

If a change were made outside the test system, a user making the change would also need authorization to re-baseline the change. Subsequently, the server and the test system running the board-test would have to be updated with the changes and the new baseline.

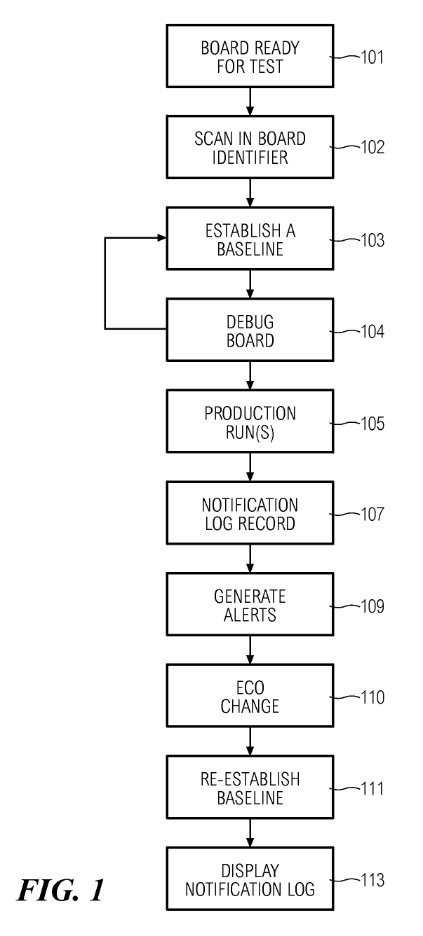

FIG. 1 is a flow chart describing a board-test tracking system using the phases described above. Block 101 describes a PCBA being readied for testing.

Block 102 describes scanning in an identifier of a board-under-test. Each time a PCBA is loaded onto a test system, the system requests the serial number of the PCBA. Typically, a bar code is scanned and recorded into the system. At the conclusion of testing, this bar code number is logged along with component failures and change records relative to the baseline.

Block 103 describes establishing a baseline for the board. The first time a baseline is run on a board-test directory, files within the directory are examined, and a revision record is created on each file. This information can be stored as elements in an array.

This can include scanning all the files used for a board-test and recording the relevant information about these files. This information can include:

i. a filename;

ii. a cyclic redundancy check;

iii. a timestamp of the change;

iv. modifications by a user; and

v. a password protected database.

Each baseline event also records other information, such as when the baseline occurred, where the baseline was performed, and by whom the baseline was created.

Block 104 describes debugging the board if necessary. If the board is altered, baselining is performed again through Block 103.

Block 105 describes running a production test. During these tests, a validation is performed on the board to match the approved baseline revisions done in Block 103. If a mismatch occurs, a notification record is generated.

Block 107 describes creating notification records that are digitally signed with a public encryption key. This public key and contents of the notification log record, when encrypted, must match a cipher key stored in the log record. This ensures data correctness and prevents record tampering. This check is performed as an action of a quality server (described later) to validate the log record. Notification log records serve to describe the status of a board-test's revision, the location and time the data was acquired, whether the changes made were approved, and if the authenticity can be validated by a digital signature.

An alert mechanism is integrated into the existing board log record. Block 109 describes generating an alert by parsing the notification log records of Block 107. The alerts are generated when errors are found in the log record. An absence of baseline data or the tampering of the digital signature are examples of errors that will generate an alert. A digitally signed and verified alert message is generated in the log record of each successfully tested board.

Block 110 describes creating an Engineering Change Order (ECO). An ECO is a specification change to a design. An ECO typically compensates for design errors found during debug or as a correction to a problem discovered after a product is released to customers. An ECO is part of a process that describes the change and tracks when the change is introduced.

Upon review of these alerts, a new baseline may be created that is accepted by an authorized user. Otherwise, an action can be taken to identify the root cause of a problem using the information within the notification log record to maintain test integrity.

Block 111 identifies establishing a new baseline for the board-test files or a subset of the files that have changed. The array is updated with the differences between the new baseline and the baseline created in Block 103.

This baselining feature helps in identifying the differences in successive baselines, and helps in keeping tracking revisions of multiple board-test files as the baseline events progress. Additionally, a baseline may be examined to associate other files within that baseline. Frequent changes in a board-test file may suggest an unstable set of testing criteria.

The notification log can also reflect information regarding the creation of a new baseline for a quality server to acknowledge the approved change. The quality server is a database wherein information can be cross-referenced and status reports generated.

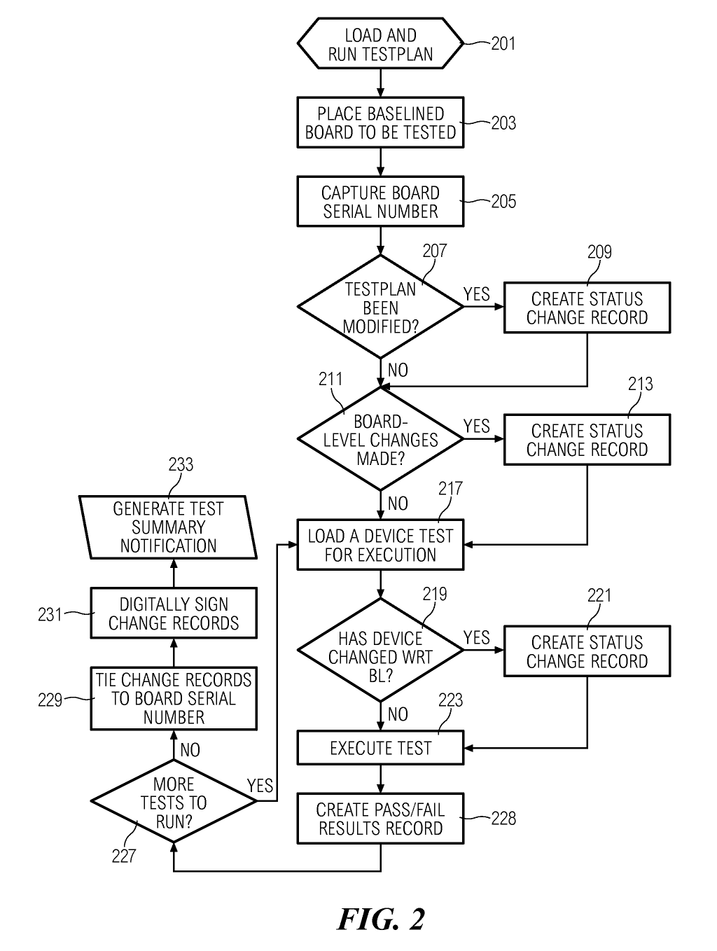

FIG. 2 is a flow chart showing a sequence for change-control detection and notification.

Block 201 describes loading and running a test-plan pertaining to the board-test. The test-plan is a component of the board-test file.

Block 203 describes placing a baselined board to be tested onto the test system.

Block 205 identifies recording the identity of the board to be tested.

Block 207 determines if the test-plan has been modified. If it has been, the flow proceeds to Block 209, wherein a status change record is created.

The flow proceeds to Block 211, wherein a determination is made if board-level changes are made with respect to the baseline created in Block 203. A board-level change can be a change to the topology, description, resources required by the board-test, test ordering, or board revisioning. If changes are made, the flow proceeds to Block 213 to record a change in the status.

The flow proceeds to Block 217 to load a device test (to test a device on the board) for execution, as determined in the test plan.

Block 219 determines if the device test has changed with respect to the baseline created in Block 203. Similarly, if changes are made, the flow proceeds to Block 221 to record a change in the status.

The flow proceeds to Block 223 to execute a test as specified in the test-plan.

Block 228 describes creating a results record on the success or failure of the board.

Block 227 determines if more tests need to be run. If this is affirmative, the flow moves to Block 217 wherein the next test identified in the test-plan is executed.

Once tests are completed, Block 229 ties the changed records to the board serial number.

In Block 231, the records are digitally signed as a way to improve security.

Block 233 describes generating a test summary notification for the tests just completed.

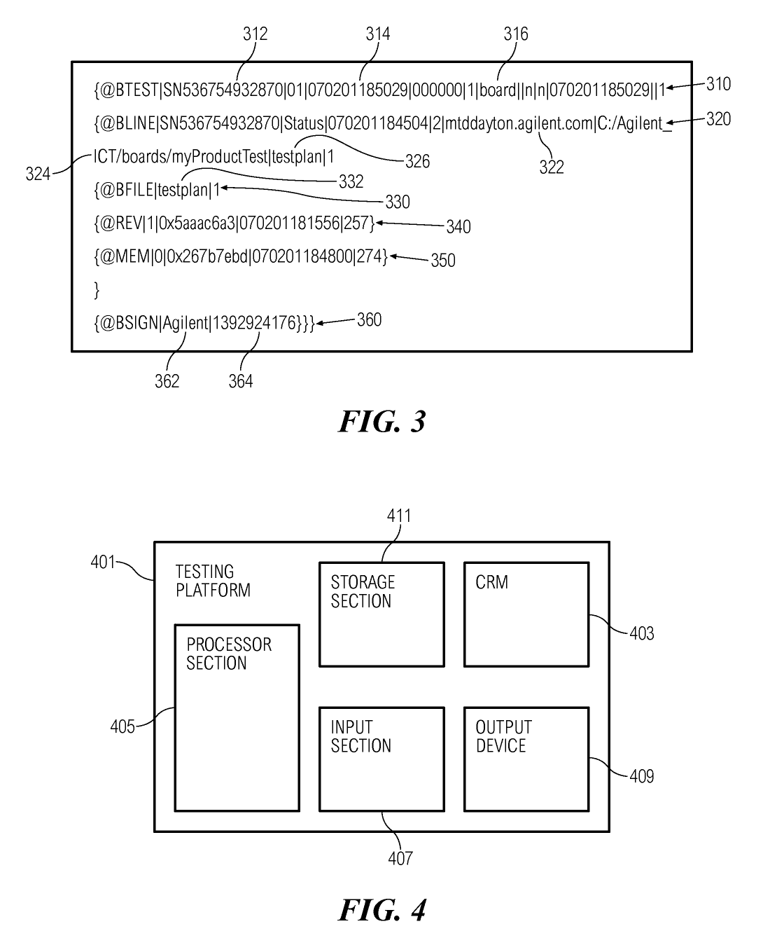

FIG. 3 is an example of fields in a notification log record to indicate that a test-plan was modified in memory relative to its baseline.

The first line 310 is a Test Collection description and identifies the board serial number 312, the timestamp 314 of testing the board, the name of the board-test 316.

The second line 320 is the baseline description and identifies the system where the board-test was run 322, the directory on the system where the board-test is run 324. The location 326 is also identified in the second line 320.

The third line 330 identifies an element 332 that has changed relative to the last baseline. The element 332 can identify a file name.

The fourth line 340 provides details of the revision number, the CRC, timestamp and file size of the element 332 in the third line 330.

The fifth line 350 describes details of an element loaded into memory. In this instance, the revision number, CRC, timestamp and file size indicate that a different element is loaded into memory.

The sixth line 360 is a signature record and identifies a public key 362 generated by a database and protected by a password created by an administrator. An encrypted digital key 364, which when deciphered correctly, will match the fields in the sixth line 360. The encrypted digital key 364 can digitally authenticate and detect changes to the fields described above.

The fields 332, 324 and 326 of the notification log record can identify precisely where the board-test files are located. The field 312 is able to associate the identity of the board with the board-tests.

FIG. 4 describes a testing platform 401 and a computer readable media 403 containing code for providing instructions to and for execution by the tester 401 in an embodiment of the invention. The computer readable media 403 can be, for example, a ROM, a RAM, a DVD, a hard drive, or other computer readable media known in the art. Also included in FIG. 4 is a storage section 411 for storing the test files, a processing section 405 for obtaining baselines of the test files, an input section 407 for instructing changes of the test files, and an output device 409 for displaying the notification log.

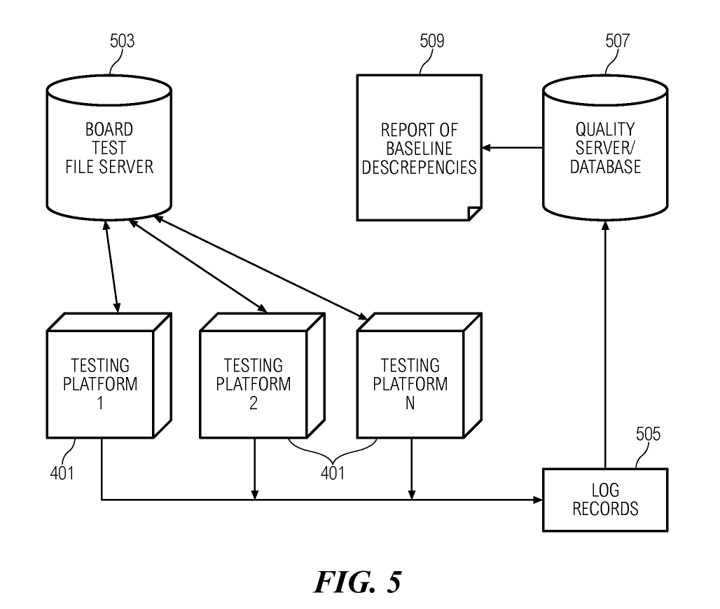

FIG. 5 is a block diagram of a manufacturing facility 501 having many testing platforms 401. The board-test files can be stored on a file server 503 and accessed remotely through a LAN connection (share drive connection) or copied down to a directory on the testing platform 401. In smaller factories, where there may be only one or two test platforms, the need for a central file repository, such as the server 503, may not be necessary.

Notification log records 505 are sent to a quality server database 507. The log records 505 are processed at the quality server database 507 to create reports 509. As the log records 505 are processed, it can validate the digital signature for log record authenticity.

While the embodiments described above constitute exemplary embodiments of the invention, it should be recognized that the invention can be varied in numerous ways without departing from the scope thereof. It should be understood that the invention is only defined by the following claims.

1. A method of tracking changes to test files to be used for testing a printed circuit board comprising:
storing the test files within a storage section of a testing platform;
obtaining a first baseline of the test files using a processor section of the testing platform;
detecting a change in the test files, the change being instructed through an input section of the testing platform, the change leading to changed test files being stored on the storage section;
creating a notification log record of the change, the notification log record generated by the processing section of the testing platform; and
obtaining a second baseline of the changed test files by the processor, if the change is approved.

2. The method of claim 1, further comprising the step of evaluating the notification log record of the change to approve or disapprove the change.

3. The method of claim 1, further comprising the step of validating the notification log record with a digital signature.

4. The method of claim 1, wherein the notification log record further comprises a serial number of the printed circuit board, the serial number of the printed circuit board being captured during testing of the printed circuit board.

5. The method of claim 1, further comprising the step of associating the change to a serial number of the printed circuit board.

6. The method of claim 1, further comprising the step of displaying the notification log record, the notification log record being displayed on an output section of the platform.

7. A system for tracking changes to test files, the test files to be used for testing a printed circuit board, the system comprising:
a testing platform to test the printed circuit board;
a storage section of the testing platform for storing the test files;
a processing section of the testing platform for obtaining a first baseline of the test files;
an input section for instructing change of the test files to create changed test files stored by the storage section;
a notification log record generated by the processing section of the testing platform for generating a notification log of the change;
a second baseline of the changed test files obtained by the processing section; and
an output device for displaying the notification log record.

8. The system of claim 7, further comprising a quality server, the quality server storing the notification log records.

9. The system of claim 7, further comprising a report to detail the change detected at the testing platform, the report being generated from the notification log record.

10. The system of claim 7, further comprising a test file server connected to the testing platform through a network connection, and wherein the test files are stored on the test file server and transferred the testing platform when required.

11. The system of claim 7, wherein the testing platform is an in-circuit test system.

12. The system of claim 7, wherein the change is associated with to a serial number of the printed circuit board.

13. A computer readable media containing code thereon, the code providing instructions to a testing platform for testing printed circuit board using test files, the code providing instructions for executing the steps of:
storing the test files within a storage section of a testing platform;
obtaining a first baseline of the test files using a processor section of the testing platform;
detecting a change in the test files, the change being instructed through an input section of the testing platform;
creating a notification log record of the change, the notification log record generated by the processing section of the testing platform; and
obtaining a second baseline of the test files including the change, if the change is approved.

14. The computer readable media containing code thereon as recited in claim 13, the code providing instructions to the testing platform for executing the additional step of creating a status change record.

15. The computer readable media containing code thereon as recited in claim 13, the code providing instructions to the testing platform for receiving as an input to the testing platform a serial number of the printed circuit board.

16. The computer readable media containing code thereon as recited in claim 13, the code providing instructions to the testing platform for executing the additional steps of connecting to a quality server and sending the notification log records to the quality server.

17. The computer readable media containing code thereon as recited in claim 13, the code providing instructions to the testing platform for executing the additional steps of connecting to a test file server to upload or download the test files when required.

18. The computer readable media containing code thereon as recited in claim 13, wherein the testing platform is an in-circuit test system.

19. The computer readable media containing code thereon as recited in claim 13, the code providing instructions to the testing platform for executing the additional step of creating a digital signature for the notification log record.

20. The computer readable media containing code thereon as recited in claim 13, the code providing instructions to the testing platform for executing the additional step of displaying the notification log record, the notification log record being displayed on an output section of the platform.
